(19) United States
(12) Patent Application Publication
(10) Pub. No.: US 2024/0271725 A1
(43) Pub. Date: Aug. 15, 2024

(54) HOLLOW COMPONENT, HOLLOW COMPONENT MANUFACTURING METHOD, AND HOLLOW COMPOMENT MANUFACTURING DEVICE

(71) Applicant: LG ELECTRONICS INC., Seoul (KR)

(72) Inventors: Yeon Sun RYU, Seoul (KR); Kyong Ho JUNG, Seoul (KR); Sung Gon KIM, Seoul (KR); Lin Pyo HONG, Seoul (KR); Gwan Sik JEONG, Seoul (KR)

(73) Assignee: LG ELECTRONICS INC., Seoul (KR)

(21) Appl. No.: 18/567,206

(22) PCT Filed: Jun. 2, 2022
(86) PCT No.: PCT/KR2022/007828

§ 371 Date: Dec. 5, 2023

(30) Foreign Application Priority Data
Jul. 29, 2021 (KR) 10-2021-0099918

(51) Int. Cl. F16L 9/133; B29C 45/00; B29K 23/00; B29K 59/00; B29K 69/00; B29K 77/00; B29L 23/00; F16L 9/00; F16L 59/04

(52) U.S. Cl. CPC F16L 9/133; F16L 9/006; F16L 59/04; B29C 2045/0093; B29K 2023/06; B29K 2023/12; B29K 2059/00; B29K 2069/00; B29K 2077/00; B29L 2023/22

(57) ABSTRACT

Disclosed are a hollow component, a method for manufacturing a hollow component, and a device for manufacturing a hollow component. The method for manufacturing a hollow component according to an embodiment of the disclosure includes a first operation of molding a first injection-molded component, a second operation of molding a second injection-molded component, a third operation of causing the first injection-molded component and the second injection-molded component to face each other, a fourth operation of approaching the first injection-molded component and the second injection-molded component, and a fifth operation of coupling the first injection-molded component and the second injection-molded component. A fastening boss of the first injection-molded component is press-fitted into a fastening hole of the second injection-molded component in the fifth operation. Therefore, the fixation between the first injection-molded component and the second injection-molded component may be achieved without additional injection, and breakage and damage of the fastening boss and the fastening hole may be prevented.

### TECHNICAL FIELD

hollow component manufacturing method, and a hollow component manufacturing device and, more specifically, to a method and a device for manufacturing a hollow component by using injection molding, and a hollow component manufactured thereby.

### BACKGROUND ART

A duct configured such that a fluid flows therein corresponds to a hollow component.

In connection with manufacturing a component such as the duct, an upper component and a lower component may be manufactured first, and both ends of the upper component and both ends of the lower component may be assembled to each other, thereby forming a duct.

Examples of conventional manufacturing schemes are as follows: an upper component and a lower component are separately provided, separately injection-molded by adding a fastening structure (for example, hooks or screws), and fastened through a separate assembly process; or an upper component and a lower component are separately provided, a space is formed on a split surface during primary injection, and a high-temperature polymer is introduced into the space during secondary injection, thereby bonding the upper and lower components.

Japanese Registered Patent Publication JP 6189371 B2 discloses a method for forming a hollow molded component and, more particularly, to a method for forming a hollow molded component, wherein a pair of semi-hollow molded components are molded (primary molding), the pair of semi-hollow molded components obtained through the primary molding are made to abut each other, and the abutting parts are injection-filled with molten resin such that the pair of semi-hollow molded components are integrated (secondary molding), thereby forming a hollow molded component.

According to Japanese Registered Patent Publication JP 6189371 B2, a cavity for bonding is configured if the pair of semi-hollow molded components abut each other, and the pair of semi-hollow molded components may be integrated by filling the cavity for bonding with molten resin.

### DISCLOSURE OF INVENTION

### Technical Problem

A problem to be solved by the disclosure is to provide a method and a device wherein, in connection with manufacturing a hollow component configured by a first split surface and a second split surface abutting each other, a first injection-molded component having a first split surface and a second injection-molded component having a second split surface are molded, and the first injection-molded component and the second injection-molded component then can be coupled and fixed without an additional injection process.

Another problem to be solved by the disclosure is to provide a method and a device wherein, in connection with manufacturing a hollow component configured by a first split surface of a first injection-molded component and a second split surface of a second injection-molded component abutting each other, the first injection-molded component and the second injection-molded component are partially press-fitted to each other, and the press-fitted parts can be prevented from being broken or damaged.

Another problem to be solved by the disclosure is to provide a method and a device wherein, in connection with manufacturing a hollow component which is configured by a first split surface of a first injection-molded component and a second split surface of a second injection-molded component abutting each other, and which is formed by foaming heat-insulating layers on outsides of the first and second injection-molded components, the first and second injection-molded components are stably fixed to each other, the inside of the hollow component is stably sealed hermetically, and infiltration of a foaming liquid into the first and second injection-molded components can be prevented.

Another problem to be solved by the disclosure is to provide a hollow component manufactured by the above method and device.

### Solution to Problem

A method for manufacturing a hollow component described disclosed herein may be a method for manufacturing a hollow component formed by contacting a first split surface and a second split surface to each other.

The method for manufacturing a hollow component may include a first operation, a second operation, a third operation, a fourth operation, and the fifth operation.

In the first operation, a first injection-molded component having the first split surface and a fastening boss may be injection-molded by a first mold.

In the second operation, a second injection-molded component having the second split surface and a fastening hole may be injection-molded by a second mold.

Each of the first mold and the second mold may be opened after the first operation and the second operation.

In the third operation, one of the first injection-molded component and the second injection-molded component may be moved such that the first split surface and the second split surface face each other.

In the fourth operation, the first injection-molded component and the second injection-molded component may be relatively moved to approach each other, the first split surface and the second split surface may approach each other, and the fastening boss may be simultaneously inserted into the fastening.

In the fifth operation, the first injection-molded component and the second injection-molded component may be relatively moved additionally such that the first split surface and the second split surface abut each other, and the fastening boss is press-fitted into the fastening hole.

In the first operation, multiple fastening bosses are formed and spaced apart from each other along a longitudinal direction of the first split surface.

In the second operation, multiple fastening holes are formed and spaced apart from each other along a longitudinal direction of the second split surface.

In the fifth operation, the fastening bosses are press-fitted into the fastening holes, respectively.

The method for manufacturing a hollow component according to an embodiment of the disclosure may be performed as a die slide injection (DSI) mold process. The first operation and the second operation may be simultaneously performed.

In the fifth operation, when the fastening boss is press-fitted into the fastening hole, an end part of the fastening boss may protrude out of the fastening hole.

An outer diameter of the fastening boss formed in the first operation may be larger than an outer diameter of the fastening hole formed in the second operation.

A temperature of the first injection-molded component and the second injection-molded component in the fifth operation may be 40° C. or higher.

In the first operation, the first split surface may protrude in a direction in parallel with the fastening boss along a longitudinal direction of the first split surface such that a first protruding ledge is formed.

In the second operation, the second split surface may protrude in a direction facing the first protruding ledge along a longitudinal direction of the second split surface such that a second protruding ledge is formed.

The first protruding ledge and the second protruding ledge may be brought into close contact with each other in an inward/outward direction in the fifth operation.

The first protruding ledge formed in the first operation may be separated into a first inner protruding ledge and a first outer protruding ledge spaced apart from each other in an inward/outward direction.

The second protruding ledge formed in the second operation may be separated into a second inner protruding ledge and a second outer protruding ledge spaced apart from each other in an inward/outward direction.

In the fifth operation, the first inner protruding ledge, the second inner protruding ledge, the first outer protruding ledge, and the second outer protruding ledge may be brought into close contact with each other in this order, or the second inner protruding ledge, the first inner protruding ledge, the second outer protruding ledge, and the first outer protruding ledge may be brought into close contact with each other in this order.

The method for manufacturing a hollow component may further include a sixth operation.

The sixth operation may be performed after the fifth operation.

In the sixth operation, an insulation layer configured to surround the first injection-molded component and the second injection-molded component may be formed by foaming.

A device for manufacturing a hollow component disclosed herein may be a device for manufacturing a hollow component formed by contacting a first split surface and a second split surface to each other.

The device for manufacturing a hollow component may include a first mold, a second mold, a first actuator, and a second actuator.

The first mold may be formed to injection-mold a first injection-molded component having the first split surface and a fastening boss, and may include a first outer mold and a first inner mold.

The second mold may be formed to injection-mold a second injection-molded component having the second split surface and a fastening hole, and may include a second outer mold and a second inner mold.

The first actuator may be formed to close or open the first outer mold and the first inner mold with regard to each other and configured to close or open the second outer mold and the second inner mold with regard to each other.

The second actuator may move one or more of the first injection-molded component and the second injection-molded component such that the first split surface and the second split surface face each other in a state in which the first outer mold and the first inner mold are opened with regard to each other and the second outer mold and the second inner mold are opened with regard to each other.

The first actuator may be formed to relatively move the first injection-molded component and the second injection-molded component in a state in which the first split surface and the second split surface face each other such that the first split surface and the second split surface abut each other, and the fastening boss is inserted and press-fitted into the fastening hole.

The first mold may be formed to have multiple fastening bosses formed spaced apart from each other along a longitudinal direction of the first split surface.

The second mold may be formed to have multiple fastening holes formed spaced apart from each other along a longitudinal direction of the second split surface.

The first actuator and the second actuator may be formed to relatively move the first injection-molded component and the second injection-molded component such that the fastening bosses are press-fitted into the fastening hole, respectively.

The first outer mold and the second inner mold may be formed integrally with each other.

The first inner mold and the second outer mold may be formed integrally with each other.

The first inner mold may be provided with a fastening boss formation hole configured to form the fastening boss.

The second inner mold may be provided with a fastening hole formation protrusion configured to form the fastening hole.

The second outer mold may be provided with a fastening hole formation groove into which an end part of the fastening hole formation protrusion is inserted.

A length of the fastening hole formation protrusion may be formed to be longer than or equal to a length of the fastening boss formation hole.

A diameter of the fastening boss formation hole may be formed to be larger than a diameter of the fastening hole formation protrusion.

When the fastening boss is press-fitted into the fastening hole by the first actuator, a temperature of the first mold and the second mold may be formed to be 40° C. or higher.

The first inner mold may be provided with a concave first protruding ledge formation groove such that the first split surface protrudes in a direction in parallel with the fastening boss along a longitudinal direction of the first split surface, thereby forming a first protruding ledge.

The second inner mold may be provided with a concave second protruding ledge formation groove such that the second split surface protrudes in a direction facing the first protruding ledge along a longitudinal direction of the second split surface, thereby forming a second protruding ledge.

The first actuator and the second actuator may be formed to relatively move the first injection-molded component and the second injection-molded component such that the first protruding ledge and the second protruding ledge are brought into close contact with each other in an inward/outward direction.

The first protruding ledge formation groove may be separated into a first inner protruding ledge formation groove in which the first inner protruding ledge is formed, and a first outer protruding ledge formation groove in which the first outer protruding ledge is formed such that the first protruding ledge is separated into a first inner protruding ledge and a first outer protruding ledge spaced from each other in an inward/outward direction.

The second protruding ledge formation groove may be separated into a second inner protruding ledge formation groove in which the first inner protruding ledge is formed, and a second outer protruding ledge formation groove in which the second outer protruding ledge is formed such that the second protruding ledge is separated into a second inner protruding ledge and a second outer protruding ledge spaced from each other in an inward/outward direction.

The first actuator and the second actuator may be formed to relatively move the first injection-molded component and the second injection-molded component such that the first inner protruding ledge, the second inner protruding ledge, the first outer protruding ledge, and the second outer protruding ledge are brought into close contact with each other in this order, or the second inner protruding ledge, the first inner protruding ledge, the second outer protruding ledge, and the first outer protruding ledge are brought into close contact with each other in this order.

A hollow component may be manufactured by the above-described method for manufacturing a hollow component.

A hollow component may be manufactured by the above-described device for manufacturing a hollow component.

### Advantageous Effects of Invention

According to a hollow component manufacturing method and a hollow component manufacturing device according to an embodiment of the disclosure, a hollow component may be manufactured by a first split surface and a second split surface abutting each other, a fastening boss is press-fitted to a fastening hole such that a first injection-molded component and a second injection-molded component are coupled and fixed to each other, no additional injection process is necessary in this connection, and the hollow component can be manufactured easily while saving materials.

According to a hollow component manufacturing method and a hollow component manufacturing device according to an embodiment of the disclosure, a fastening boss enters a fastening boss and is press-fitted thereto while a first injection-molded component and a second injection-molded component are position inside a mold, the temperature of the fastening boss and the fastening hole can thus be maintained in a predetermined range (without being cooled to a room temperature range), and both can be firmly coupled without the fastening boss and/or the fastening hole being broken.

According to a hollow component manufacturing method and a hollow component manufacturing device according to an embodiment of the disclosure, a first protruding ledge is formed on a first injection-molded component, a second protruding ledge is formed on a second injection-molded component, and the first and second protruding ledges are forced against each other in the inward/outward direction, thereby coupling the first and second injection-molded components to each other. In addition, the first protruding ledge may be divided into a first inner protruding ledge and a first outer protruding ledge, and the second protruding ledge may be divided into a second inner protruding ledge and a second outer protruding ledge. Accordingly, the first and second protruding ledges may be coupled so as to engage with each other, thereby facilitating stable coupling between the first and second injection-molded components. In addition, the first and second protruding ledges guarantee that the inside of the hollow component is stably sealed hermetically, and may prevent a foaming liquid from infiltrating the first and second injection-molded components.

Additional advantageous effects exhibited by a hollow component, a hollow component manufacturing method, and a hollow component manufacturing device according to an embodiment of the disclosure will be described in the following with reference to the accompanying drawings.

### BRIEF DESCRIPTION OF DRAWINGS

FIG. 1A is a perspective view illustrating a hollow component according to an embodiment of the disclosure.

FIG. 1B is a perspective view separately illustrating a first injection-molded component and a second injection-molded component of a hollow component according to an embodiment of the disclosure.

FIG. 2A is a sectional view of a hollow component 10 according to an embodiment of the disclosure.

FIG. 2B is a view separately illustrating a section of a first injection-molded component and a section of a second injection-molded component of FIG. 2A.

FIG. 3A is a sectional view of a hollow component at portion thereof in which a fastening boss and a fastening hole are coupled to each other.

FIG. 3B is a view illustrating a first injection-molded component and a second injection-molded component of FIG. 3A, which are separate from each other.

FIG. 4A is a sectional view of a hollow component at a portion in which a first protruding ledge and a second protruding ledge are coupled to each other.

FIG. 4B is a view illustrating a separate state of a first injection-molded component and a second injection-molded component of FIG. 4A.

FIG. 5A is a sectional view illustrating a separate state of a fastening boss of a first injection-molded component and a fastening hole of a second injection-molded component.

FIG. 5B is a sectional view illustrating a fastening boss of a first injection-molded component and a fastening hole of a second injection-molded component, which are coupled to each other.

FIG. 6 is a view illustrating a method for manufacturing a hollow component according to an embodiment of the disclosure.

FIG. 7A is a sectional view illustrating a first mold according to an embodiment of the disclosure, and FIG. 7B is a sectional view illustrating a second mold according to an embodiment of the disclosure.

FIG. 8A and FIG. 8B are sectional views illustrating a device for manufacturing a hollow component according to an embodiment of the disclosure, respectively.

FIG. 9 is a view illustrating a process order of a method for manufacturing a hollow component according to an embodiment of the disclosure.

FIG. 10 is a schematic view illustrating an operation order of a device for manufacturing a hollow component during manufacturing the hollow component according to an embodiment of the disclosure.

FIG. 11 is a schematic view illustrating an operation order of each mold constituting a device for manufacturing a hollow component during manufacturing the hollow component according to an embodiment of the disclosure.

FIG. 12 is a sectional view illustrating a coupling portion of a fastening boss and a fastening hole in a hollow component according to an embodiment of the disclosure.

FIG. 13 is a view illustrating a process order of a method for manufacturing a hollow component according to an embodiment of the disclosure.

FIG. 14 is a sectional view illustrating a section of a hollow component according to an embodiment of the disclosure.

### MODE FOR THE INVENTION

Hereinafter, in order to describe the disclosure in more detail, embodiments of the disclosure will be described in more detail with reference to the accompanying drawings. Like numbers refer to like elements throughout the description of the figures.

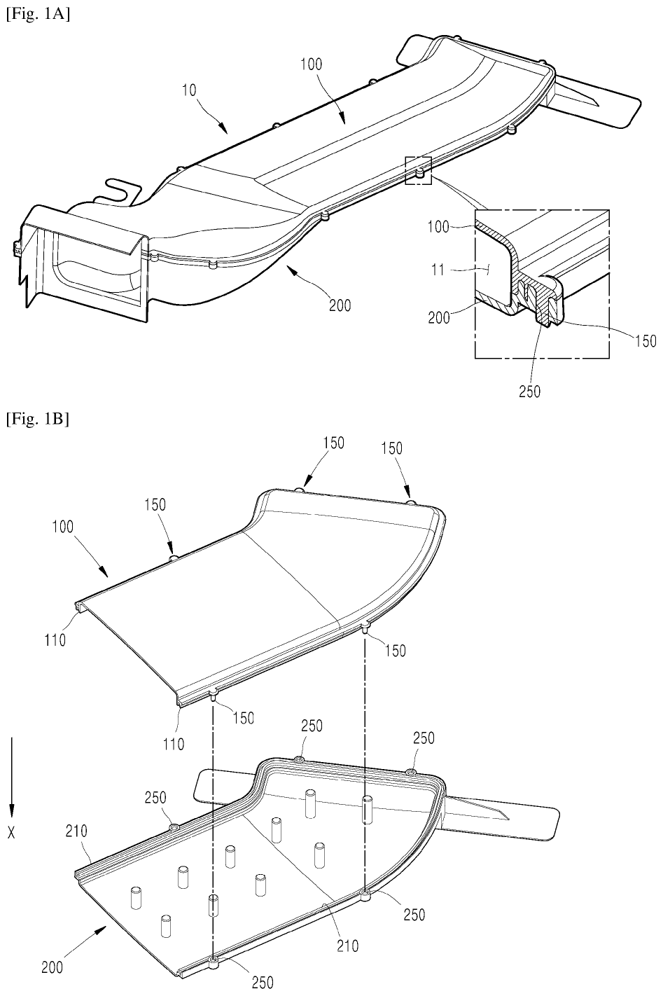

FIG. 1A is a perspective view illustrating a hollow component 10 according to an embodiment of the disclosure, and FIG. 1B is a perspective view separately illustrating a first injection-molded component 100 and a second injection-molded component 200 of a hollow component 10 according to an embodiment of the disclosure. FIG. 1B illustrate only a portion of the hollow component 10 of FIG. 1A.

The hollow component 10 according to an embodiment of the disclosure is a component having an empty inside and includes a space 11 therein. In an embodiment, the hollow component 10 may be formed to have a pipe shape, a duct shape, and the like.

The hollow component 10 according to an embodiment of the disclosure may have a structure to allow a fluid to flow therein. The hollow component 10 according to an embodiment of the disclosure may be a duct for a refrigerator or a component including a duct for a refrigerator.

The hollow component 10 may be separated into two parts, that is a first injection-molded component 100 and a second injection-molded component 200.

The first injection-molded component 100 and the second injection-molded component 200 are formed by injection molding. Various plastic resins may be used for a material of the first injection-molded component 100 and the second injection-molded component 200. According to an embodiment, each of the first injection-molded component 100 and the second injection-molded component 200 may include or be formed of polyethylene (PE), polypropylene (PP), polyamide (PA), polyacetal (POM), polycarbonate (PC), or the like.

A plastic resin included in a molded material for the first injection-molded component 100 and the second injection-molded component 200 may be injected into a mold in a molten state to be molded in the first injection-molded component 100 and the second injection-molded component 200.

A molding temperature for the first injection-molded component 100 and the second injection-molded component 200 may be set to be suitable for each plastic resin, for example, when a PP resin is used as a material for the first injection-molded component 100 and the second injection-molded component 200, the PP resin may be formed to have a molding temperature of 180-270° C.

When each of the first injection-molded component 100 and the second injection-molded component 200 is molded by injection molding, a mold (first mold 30) configured to form the first injection-molded component 100 and a mold (second mold 50) configured to form the second injection-molded component 200 may be heated to a predetermined temperature, respectively.

When the first injection-molded component 100 is formed, a temperature of the first mold 30 may be controlled within a predetermined temperature range. When the first injection-molded component 100 is formed, in an embodiment, the temperature of the first mold 30 may be controlled within a temperature range of 40-180° C., and in another embodiment, the temperature of the first mold 30 may be controlled within a temperature range of 70-120° C.

When the second injection-molded component 200 is formed, a temperature of the second mold 50 may be controlled within a predetermined temperature range. When the second injection-molded component 200 is formed, in an embodiment, the temperature of the second mold 50 may be controlled within a temperature range of 40-180° C., and in another embodiment, the temperature of the second mold 50 may be controlled within a temperature range of 70-120° C.

After each of the first injection-molded component 100 and the second injection-molded component 200 is molded by injection, the first injection-molded component 100 and the second injection-molded component 200 are assembled to each other so as to form the hollow component 10.

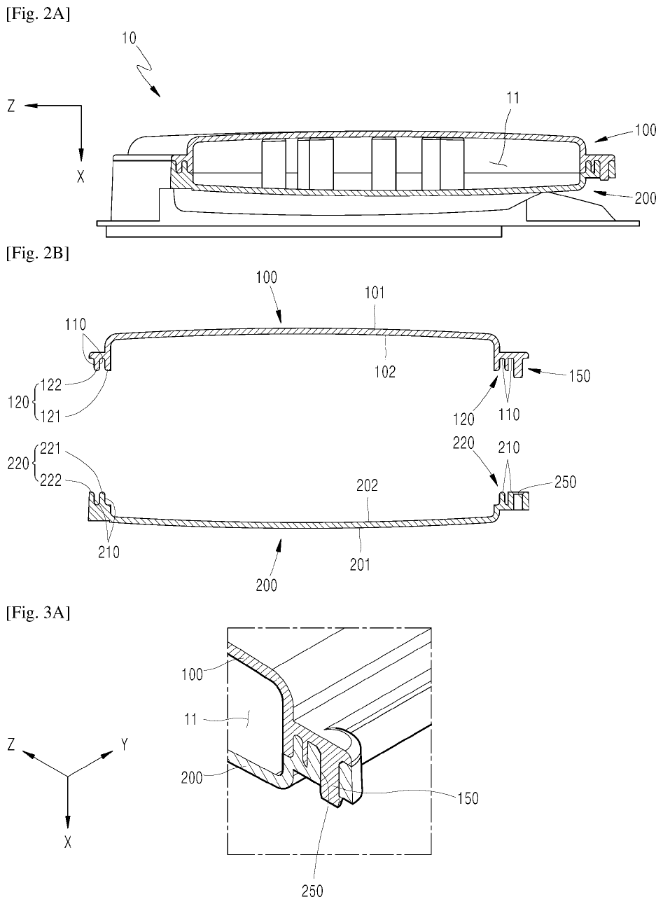

FIG. 2A is a sectional view of a hollow component 10 according to an embodiment of the disclosure, and FIG. 2B is a view illustrating a section of a first injection-molded component 100 and a section of a second injection-molded component 200 shown in FIG. 2A.

The first injection-molded component 100 includes a first split surface 110 and a fastening boss 150, and the second injection-molded component 200 includes a second split surface 210 and a fastening hole 250.

The first split surface 110 is a surface closely coupled to the second injection-molded component 200 from the first injection-molded component 100, and the second split surface 210 is a surface closely coupled to the first injection-molded component 100 from the second injection-molded component 200. When the first split surface 110 and the second surface 210 abut each other, the first injection-molded component 100 and the second injection-molded component 200 are coupled, and thus assembly of the hollow component 10 may be completed.

Each of the first injection-molded component 100 and the second injection-molded component 200 is generally formed in a semi-tubular shape, and when the first injection-molded component 100 and the second injection-molded component 200 are coupled, one complete pipe or duct shape may be formed.

In describing an embodiment of the disclosure, an inner surface 102 of the first injection-molded component 100 is a surface configured to form a portion of an inner surface of the hollow component 10, and an outer surface 101 of the first injection-molded component 100 is a surface configured to form a portion of an outer surface of the hollow component 10. In addition, an inner surface 202 of the second injection-molded component 200 is a surface configured to form a portion of an inner surface of the hollow component 10, and an outer surface 201 of the second injection-molded component 200 is a surface configured to form a portion of an outer surface of the hollow component 10.

The first split surface 110 may be formed along an edge of the first injection-molded component 100.

The first split surface 110 may be formed on both edges of the first injection-molded component 100 facing each other.

The second split surface 210 may be formed along an edge of the second injection-molded component 200.

The second split surface 210 may be formed on both edges of the second injection-molded component 200 facing each other.

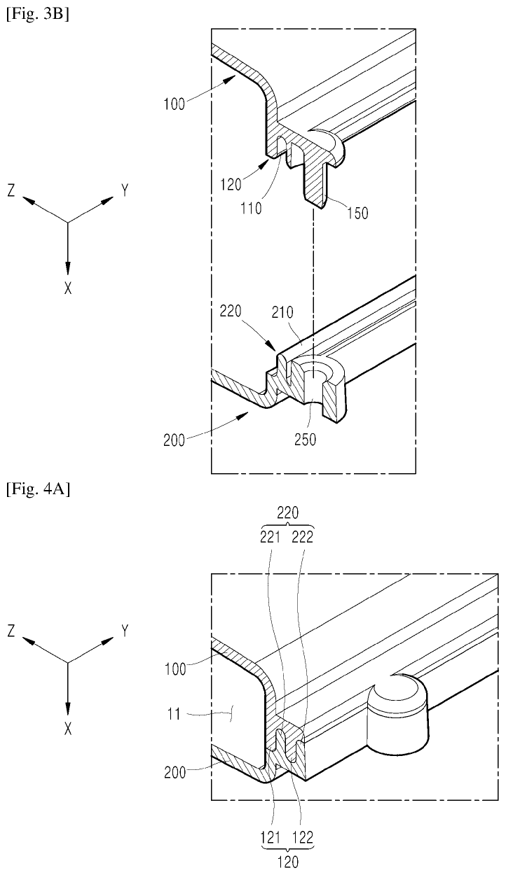

FIG. 3A is a sectional view of a hollow component 10 at a portion thereof in which a fastening boss 150 and a fastening hole 250 are coupled to each other and FIG. 3B is a view illustrating a first injection-molded component 100 and a second injection-molded component 200 of FIG. 3A, which are separate from each other.

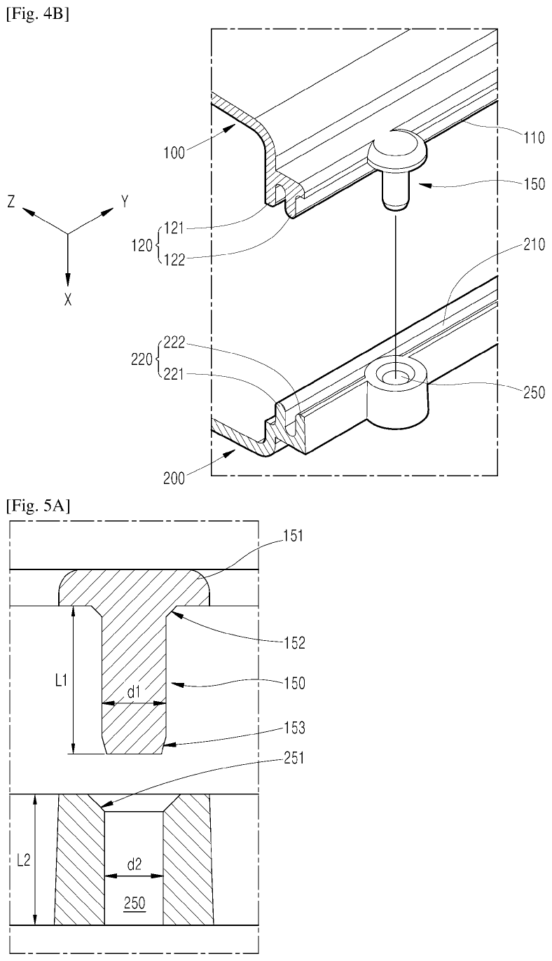

FIG. 4A is a sectional view of a hollow component 10 at a portion thereof in which a first protruding ledge 120 and a second protruding ledge 220 are coupled to each other and FIG. 4B is a view illustrating a separate state of a first injection-molded component 100 and a second injection-molded component 200 of FIG. 3A.

FIG. 5A is a sectional view illustrating a separate state of a fastening boss 150 of a first injection-molded component 100 and a fastening hole 250 of a second injection-molded component 200 and FIG. 5B is a sectional view illustrating a fastening boss 150 of a first injection-molded component 100 and a fastening hole 250 of a second injection-molded component 200, which are coupled to each other.

The fastening boss 150 may be formed in a protrusion shape protruding from an edge of the first injection-molded component 100. The fastening boss 150 may be formed in a protrusion shape protruding from the first split surface 110. The fastening boss 150 may protrude from an edge of the first injection-molded component 100 in a first direction (X).

A boss head 151 may be formed at an opposite side of an end part of the fastening boss 150. The boss head 151 is a portion in which the fastening boss 150 is connected to the first injection-molded component 100, and is formed to have a diameter larger than that of the fastening boss 150.

The first injection-molded component 100 may include a first chamfer part 152 and a second chamfer part 153.

The first chamfer part 152 is a portion in which the boss head 151 and the fastening boss 150 are connected to each other, and a chamfered portion of an edge surface formed along a circumferential direction. That is, the first chamfer part 152 is formed to have a diameter increasing from the fastening boss 150 toward the boss head 151.

The second chamfer part 153 is a chamfered portion as an edge surface of an end part of the fastening boss 150 in a circumferential direction. The second chamfer part 153 is formed to have a diameter decreasing toward the end part of the fastening boss 150 and farther away from the boss head 151.

The first split surface 110 may be formed of a flat surface or a curved surface. The first split surface 110 may be formed of a repeatedly curved surface.

The entirety or a portion of the first split surface 110 may form a surface intersecting a first direction (X), a surface orthogonal to the first direction (X), or a flat surface.

When the first direction (X) is a vertical direction and a horizontal direction, the first split surface 110 may be continuously formed along the horizontal direction.

Multiple fastening bosses 150 may be formed on the first injection-molded component 100, and each fastening boss 150 may be spaced apart from each other along an edge of the first injection-molded component 100.

When the first split surface 110 is formed at both edges of the first injection-molded component 100 facing each other, the fastening boss 150 may be also formed at both edges of the first injection-molded component 100 facing each other.

The fastening hole 250 may be formed in a penetrated hole shape through an edge of the second injection-molded component 200. The fastening hole 250 may be formed in a penetrated hole shape through the second split surface 210. The fastening boss 250 may penetrate an edge of the second injection-molded component 200 in a first direction (X).

The second injection-molded component 200 may include a third chamfer part 251.

The third chamfer part 251 is a chamfered portion as an edge surface forming an entrance of the fastening hole 250 in a circumferential direction. That is, the third chamfer part 251 is a portion where the fastening boss 150 enters first when the fastening boss 150 enters the fastening hole 250 for coupling the first injection-molded component 100 and the second injection-molded component 200.

The third chamfer part 251 is formed to have a diameter increasing from the fastening hole 250 toward the outside.

In a state in which the first injection-molded component 100 and the second injection-molded component 200 are completely coupled, that is, the fastening boss 150 is completely inserted and press-fitted into the fastening hole 250, the third chamfer part 251 may be spaced a predetermined distance apart without being in close contact with the first chamfer part 152. The spacing may help the fastening boss 150 to be sufficiently inserted into the fastening hole 250.

The second split surface 210 may be formed of a flat surface or a curved surface. The second split surface 210 may be formed of a repeatedly curved surface.

The entirety or a portion of the second split surface 210 may form a surface intersecting a first direction (X), a surface orthogonal to the first direction (X), or a flat surface.

The second split surface 210 may be formed parallel to the first split surface 110.

When the first direction (X) is a vertical direction and a horizontal direction, the second split surface 210 may be continuously formed along the horizontal direction.

Multiple fastening holes 250 may be formed through the second injection-molded component 200, and each fastening hole 250 may be spaced apart from each other along an edge of the second injection-molded component 200.

When the second split surface 210 is formed at both edges of the second injection-molded component 200 facing each other, the fastening hole 250 may be also formed through both edges of the second injection-molded component 200 facing each other.

In the hollow component 10 according to an embodiment of the disclosure, the fastening boss 150 may be formed to have a length L1 longer than a length L2 of the fastening hole 250. In addition, it may be formed that an end part of the fastening boss 150 inserted into the fastening hole 250 protrudes out of the fastening hole 250 when the fastening boss 150 is inserted into the fastening hole 250 to complete assembly of the first injection-molded component 100 and the second injection-molded component 200.

An inner circumferential surface of the fastening hole 250 may be in closed contact with an outer circumferential surface of the fastening boss 150 throughout a longitudinal direction thereof. Accordingly, a contact (coupling) area between the fastening boss 150 and the fastening hole 250 may be maximally secured.

In the hollow component 10 according to an embodiment of the disclosure, the fastening boss 150 may be formed to have a diameter (outer diameter) d1 larger than a diameter (inner diameter) d2 of the fastening hole 250.

The fastening boss 150 may be formed to have a cross section constant throughout a longitudinal direction thereof. The fastening boss 150 may be formed to have a cross section constant throughout a longitudinal direction thereof excluding the first chamfer part 152 and the second chamfer part 153.

The section of the fastening boss 150 may be formed in a circular shape, a polygonal shape, or the like.

The fastening hole 250 may be formed to have a cross section constant throughout a longitudinal direction thereof. The fastening hole 250 may be formed to have a cross section constant throughout a longitudinal direction thereof excluding the third chamfer part 251.

The section of the fastening hole 250 may be formed in a circular shape, a polygonal shape, or the like.

In an embodiment of the disclosure, when the diameter of the fastening hole 250 is formed to be 2-5 mm, the diameter of the fastening boss 150 may be formed to be larger than that of the fastening hole 250 by 0.1-0.5 mm.

In an embodiment of the disclosure, when the diameter of the fastening boss 150 is formed to be 3 mm, the diameter of the fastening hole 250 may be formed to be smaller than that of the fastening boss 150 by 0.2 mm.

Table 1 below shows fastening force (force needed when inserting the fastening boss 150 into the fastening hole 250) between the fastening boss 150 and the fastening hole 250 according to a shape and size of the fastening hole 250 during manufacturing the hollow component 10 according to an embodiment of the disclosure. Here, the diameter of the fastening boss 150 is 3 mm.

TABLE 1

| Classi- | | Fastening force (Kgf) | | | | | |
|---|---|---|---|---|---|---|---|
| fication | Size | 1 | 2 | 3 | 4 | 5 | Average |
| Hexagonal | Inner side | 0 | 0 | 0 | 0 | 0 | 0 |
| Hole | 3.0 | | | | | | |
| | Inner side | 4.3 | 4.1 | 3.2 | 2.4 | 4.9 | 3.8 |
| | 2.9 | | | | | | |
| | Inner side | 10.1 | 10.1 | 9.9 | 12.5 | 6.9 | 9.9 |
| | 2.8 | | | | | | |
| | Inner side | Natural releasing | | | | | |
| | 2.7 | | | | | | |
| | Inner side | Not insertable | | | | | |
| | 2.6 | | | | | | |
| Tubular | Φ3.0 | 0.15 | 0.2 | 0.2 | 0.2 | 0 | 0 |
| Hole | Φ2.9 | 7.4 | 14.1 | 10.1 | 8.3 | 11.1 | 10.2 |
| | Φ2.8 | 19.3 | 16.5 | 19.7 | 20.1 | 16.7 | 18.4 |

| | |
|---|---|
| Φ2.7 | Not insertable |
| Φ2.6 | Not insertable |

As shown in Table 1, it was identified that when the diameter of the fastening hole 250 is identical to the diameter of the fastening boss 150, the fastening force between the fastening boss 150 and the fastening hole 250 is zero or too small, when the diameter of the fastening hole 250 is smaller than the diameter of the fastening boss 150 by 0.3 mm or more, the insertion is impossible, and when the diameter of the fastening boss 150 is 3 mm and the diameter of the fastening hole 250 is smaller than the diameter of the fastening boss 150 by about 0.2 mm, the fastening force between the fastening boss 150 and the fastening hole 250 is appropriate. Table 2 below shows separation force (force needed when separating the fastening boss 150 from the fastening hole 250) between the fastening boss 150 and the fastening hole 250 according to a shape and size of the fastening hole 250 during manufacturing the hollow component 10 according to an embodiment of the disclosure. Here, the diameter of the fastening boss 150 is 3 mm.

TABLE 2

| Classi- | | Separation force (Kgf) | | | | | |
|---|---|---|---|---|---|---|---|
| fication | Size | 1 | 2 | 3 | 4 | 5 | Average |
| Hexagonal | Inner side | 0 | 0 | 0 | 0 | 0 | 0 |
| Hole | 3.0 | | | | | | |
| | Inner side | 6.0 | 5.3 | 2.9 | 4.1 | 5.7 | 4.8 |
| | 2.9 | | | | | | |
| | Inner side | 12.3 | 10.6 | 11.0 | 17.2 | 7.9 | 11.8 |
| | 2.8 | | | | | | |
| | Inner side | Natural releasing | | | | | |
| | 2.7 | | | | | | |
| | Inner side | Not insertable | | | | | |
| | 2.6 | | | | | | |
| Tubular | Φ3.0 | 0.15 | 0.2 | 0.2 | 0.2 | 0 | 0 |
| Hole | Φ2.9 | 7.4 | 13.1 | 12.3 | 9.4 | 9.7 | 10.3 |
| | Φ2.8 | 24.1 | 19.5 | 21.5 | 23.1 | 17.9 | 21.2 |

| | |
|---|---|
| Φ2.7 | Not insertable |
| Φ2.6 | Not insertable |

As shown in Table 2, it was identified that when the diameter of the fastening hole 250 is identical to the diameter of the fastening boss 150, the separation force between the fastening boss 150 and the fastening hole 250 is zero or very small, when the diameter of the fastening hole 250 is smaller than the diameter of the fastening boss 150 by 0.3 mm or more, the insertion is impossible, and when the diameter of the fastening boss 150 is 3 mm and the diameter of the fastening hole 250 is smaller than the diameter of the fastening boss 150 by about 0.2 mm, the separation force between the fastening boss 150 and the fastening hole 250 is appropriate. A first protruding ledge 120 may be formed on the first injection-molded component 100.

The first protruding ledge 120 may be formed by the first split surface 110 protruding to one side.

The first protruding ledge 120 may be formed by the first split surface 110 protruding in a direction parallel with a protruding ledge direction of the fastening boss 150. The first protruding ledge 120 may protrude in the first direction (X).

The first protruding ledge 120 may be formed continuously or repeatedly along a longitudinal direction (a forming direction of an edge of the first injection-molded component 100) of the first split surface 110.

The longitudinal direction of the first split surface 110 may be a second direction (Y) orthogonal to the first direction (X).

The first protruding ledge 120 may be formed in the entire longitudinal direction of the first split surface 110. That is, the first protruding ledge 120 may be formed in the entire section of an edge of the first injection-molded component 100.

The first protruding ledge 120 may be separated into a first inner protruding ledge 121 and a first outer protruding ledge 122 spaced apart in an inward/outward direction. The first inner protruding ledge 121 is positioned relatively inside and the first outer protruding ledge 122 is positioned relatively outside. Each of the first inner protruding ledge 121 and the first outer protruding ledge 122 may be formed in a shape in which the first split surface 110 protrudes in the first direction (X).

The inward/outward direction described in an embodiment of the disclosure is a direction from the inside to the outside of the hollow component 10, or a direction from the outside to the inside of the hollow component 10. The inward/outward direction may be formed parallel with a third direction (Z) and the third direction may be a direction orthogonal to the first direction (X) and the second direction (Y).

A second protruding ledge 220 may be formed on the second injection-molded component 200.

The second protruding ledge 220 may be formed by the second split surface 210 protruding to one side.

The second protruding ledge 220 may be formed by the second split surface 210 protruding parallel with a forming direction of the fastening hole 250. The second protruding ledge 220 may be formed by the second split surface 210 protruding facing a protruding direction of the first protruding ledge 120. The second protruding ledge 220 may protrude in a direction opposite to the first direction (X).

The second protruding ledge 220 may be formed continuously or repeatedly along a longitudinal direction (a forming direction of an edge of the second injection-molded component 200) of the second split surface 210.

The longitudinal direction of the second split surface 210 may be a second direction (Y) orthogonal to the first direction (X).

The second protruding ledge 220 may be formed in the entire longitudinal direction of the second split surface 210. That is, the second protruding ledge 220 may be formed in the entire section of an edge of the second injection-molded component 200.

The second protruding ledge 220 may be separated into a second inner protruding ledge 221 and a second outer protruding ledge 222 spaced apart in the inward/outward direction. The second inner protruding ledge 221 is positioned relatively inside and the second outer protruding ledge 222 is positioned relatively outside. Each of the second inner protruding ledge 221 and the second outer protruding ledge 222 may be formed in a shape in which the second split surface 210 protrudes in a direction opposite to the first direction (X).

In an embodiment, in a state in which the first injection-molded component 100 and the second injection-molded component 200 are coupled to each other, the first protruding ledge 120 and the second protruding ledge 220 may be in close contact with each other in the inward/outward direction.

In an embodiment, in a state in which the first injection-molded component 100 and the second injection-molded component 200 are coupled to each other, the first inner protruding ledge 121, the second inner protruding ledge 221, the first outer protruding ledge 122, and the second outer protruding ledge 222 may be in close contact with each other in this order.

In an embodiment, in a state in which the first injection-molded component 100 and the second injection-molded component 200 are coupled to each other, the second inner protruding ledge 221, the first inner protruding ledge 121, the second outer protruding ledge 222, and the first outer protruding ledge 122 may be in close contact with each other in this order.

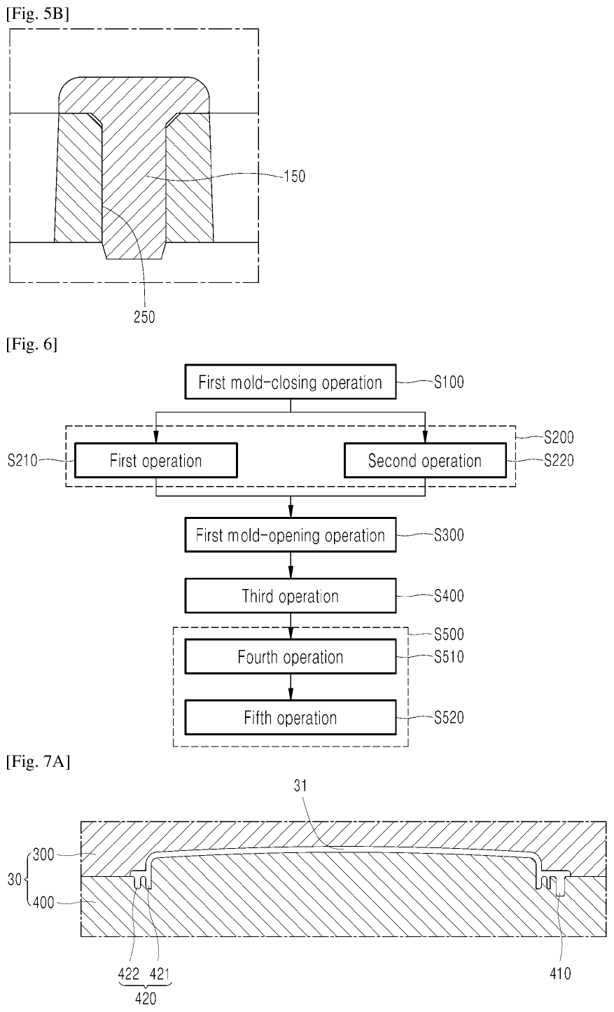

FIG. 6 is a view illustrating a method for manufacturing a hollow component according to an embodiment of the disclosure.

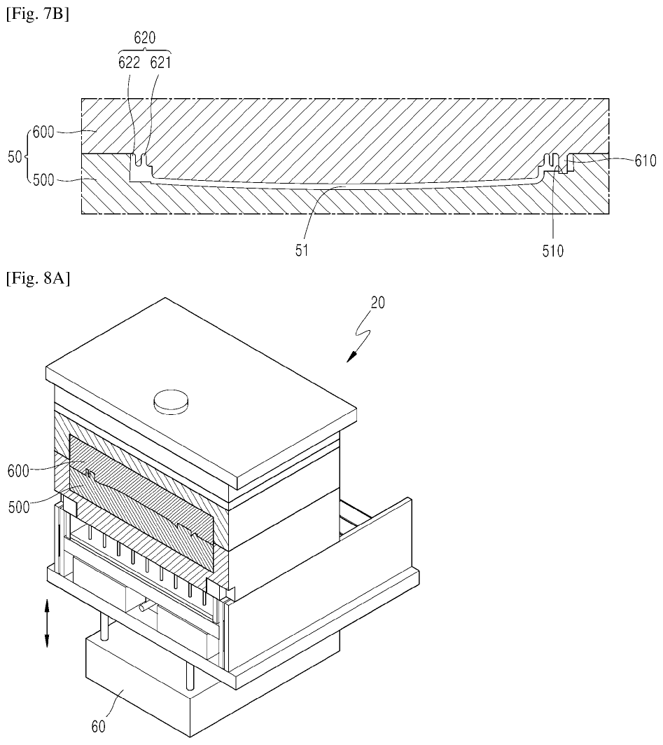

FIG. 7A is a sectional view illustrating a first mold 30 according to an embodiment of the disclosure, and FIG. 7B is a sectional view illustrating a second mold 50 according to an embodiment of the disclosure.

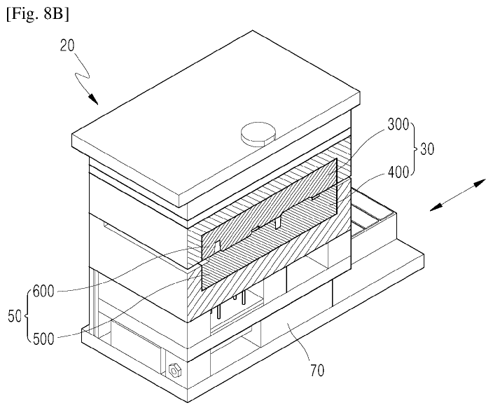

FIG. 8A and FIG. 8B are sectional views illustrating a device 20 for manufacturing a hollow component according to an embodiment of the disclosure, respectively. The sectional view of FIG. 8A and the sectional view of FIG. 8B are orthogonal to each other.

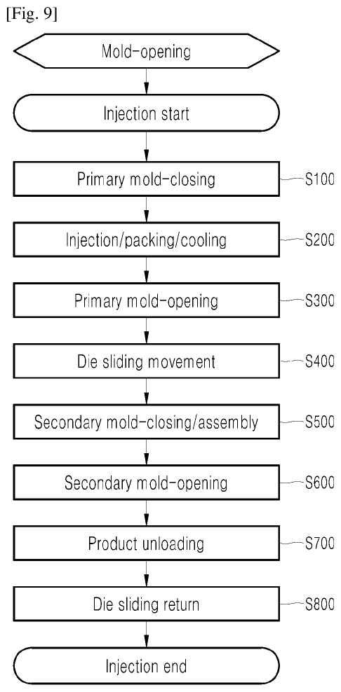

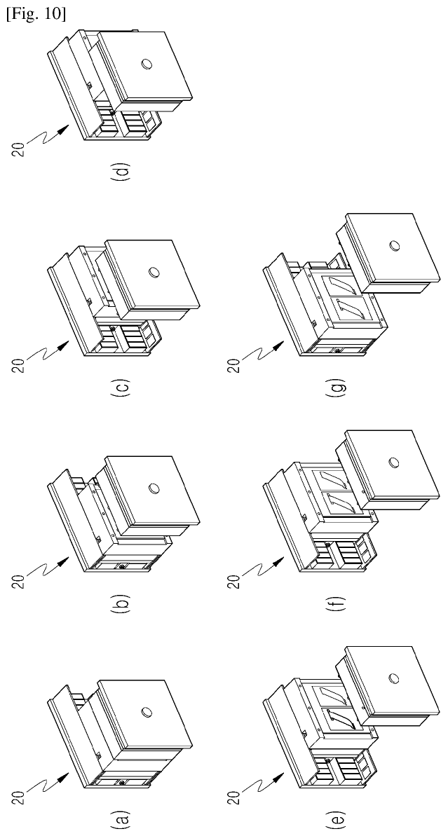

FIG. 9 is a view illustrating a process order of a method for manufacturing a hollow component according to an embodiment of the disclosure.

FIG. 10 is a schematic view illustrating an operation order of a device for manufacturing a hollow component during manufacturing the hollow component according to an embodiment of the disclosure. Each operation is performed in alphabetical order in FIG. 10.

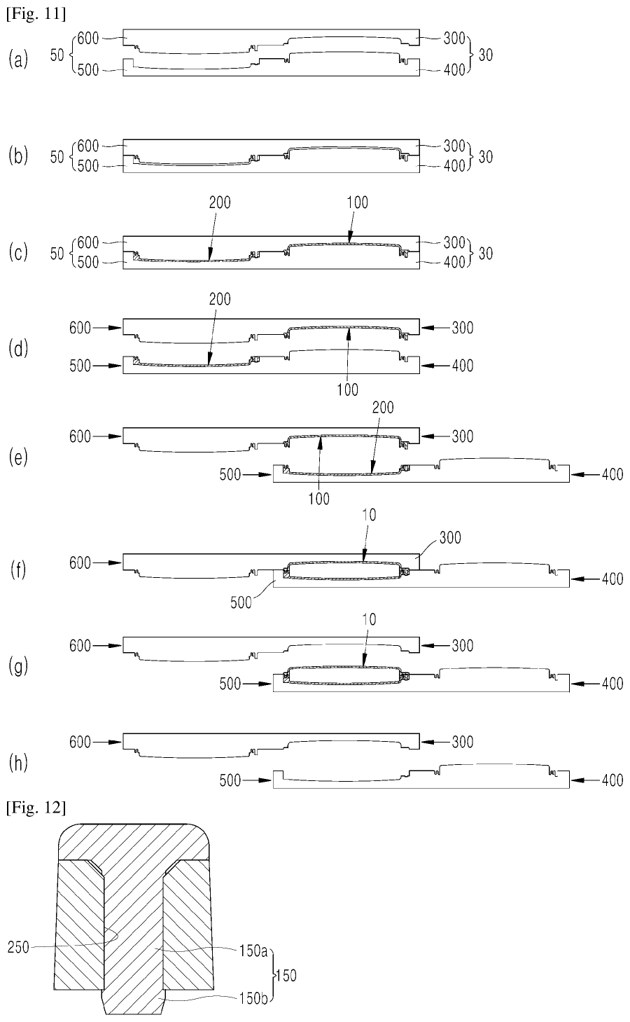

FIG. 11 is a schematic view illustrating an operation order of each mold constituting a device for manufacturing a hollow component during manufacturing a hollow component according to an embodiment of the disclosure. Each operation is performed in alphabetical order in FIG. 11.

The method for manufacturing a hollow component and the device 20 for manufacturing a hollow component according to an embodiment of the disclosure are for manufacturing the hollow component 10, and the first injection-molded component 100 and the second injection-molded component 200 are manufactured first and then the hollow component 10 is manufactured.

The method for manufacturing a hollow component according to an embodiment of the disclosure may include a first operation (S210), a second operation (S220), a first mold-opening operation (S300), a third operation (S400), a fourth operation (S510), and a fifth operation (S520).

The method for manufacturing a hollow component according to an embodiment of the disclosure may further include a second mold-opening operation (S600), a product unloading operation (S700), and a mold return operation (S800).

Meanwhile, the device 20 for manufacturing a hollow component according to an embodiment of the disclosure may include a first mold 30, a second mold 50, a first actuator 60, and a second actuator 70.

The device 20 for manufacturing a hollow component according to an embodiment of the disclosure may include a die slide injection molding (DSI) mold. Here, the first mold 30 and the second mold 50 may constitute the DSI mold.

The method for manufacturing a hollow component includes a first mold-closing operation (S100) (see (a) in FIG. 10 and (b) in FIG. 11).

The first mold 30 is a mold used for injection molding of the first injection-molded component 100, and may include a first outer mold 300 and a first inner mold 400.

The first outer mold 300 is a mold configured to form an outer surface side of the first injection-molded component 100, and the first inner mold 400 is a mold configured to form an inner surface side of the first injection-molded component 100.

In the first mold-closing operation (S100), the first outer mold 300 and the first inner mold 400 are closed with regard to each other.

The first mold 30 may be formed to have a shape in which multiple fastening bosses 150 are formed spaced apart from each other along a longitudinal direction of the first split surface 110 when the first injection-molded component 100 is molded by injection.

A fastening boss formation hole 410 configured to form the fastening boss 150 may be formed on the first inner mold 400. The fastening boss formation hole 410 may be formed to have a groove shape concave in the first direction (X).

A concave first protruding ledge formation groove 420 may be formed on the first inner mold 400 and configured to form a first protruding ledge 120 protruding from the first split surface 110 along a longitudinal direction of the first split surface 110.

The first protruding ledge formation groove 420 may be separated into a first inner protruding ledge formation groove 421 in which the first inner protruding ledge 121 is formed and a first outer protruding ledge formation groove 422 in which the first outer protruding ledge 122 is formed.

The second mold 50 is a mold used for injection molding of the second injection-molded component 200, and may include a second outer mold 500 and a second inner mold 600.

The second outer mold 500 is a mold configured to form an outer surface side of the second injection-molded component 200, and the second inner mold 600 is a mold configured to form an inner surface side of the second injection-molded component 200.

In the first mold-closing operation (S100), the second outer mold 500 and the second inner mold 600 are closed with regard to each other.

The second mold 50 may be formed to have a shape in which multiple fastening holes 250 are formed spaced apart from each other along a longitudinal direction of the second split surface 210 when the second injection-molded component 200 is molded by injection.

A fastening hole formation protrusion 610 configured to form the fastening hole 250 may be formed on the second inner mold 600. The fastening hole formation protrusion 610 is formed to have a convex protrusion shape protruding in the first direction (X).

A fastening hole formation groove 510, into which an end part of the fastening hole formation protrusion 610 is inserted may be formed when the second outer mold 500 and the second inner mold 600 are closed with regard to each other, may be formed on the second outer mold 500. The fastening hole formation groove 510 may be formed to have a groove shape concave in the first direction (X).

In an embodiment of the disclosure, a length of the fastening hole formation protrusion 610 may be formed to be longer than or equal to a length of the fastening boss formation hole 410.

In an embodiment of the disclosure, a diameter of the fastening boss formation hole 410 may be formed to be larger than a diameter (outer diameter) of the fastening hole formation protrusion 610.

A concave second protruding ledge formation groove 620 may be formed on the second inner mold 600 and configured to form a second protruding ledge 220 protruding from the second split surface 210 along a longitudinal direction of the second split surface 210.

The second protruding ledge formation groove 620 may be separated into a second inner protruding ledge formation groove 621 in which the second inner protruding ledge 221 is formed and a second outer protruding ledge formation groove 622 in which the second outer protruding ledge 222 is formed.

The closing of the first outer mold 300 and the first inner mold 400 and the closing of the second outer mold 500 and the second inner mold 600 may be simultaneously performed.

In the first operation (S210), the first injection-molded component 100 having the first split surface 110 and the fastening boss 150 is injection molded by the first mold 30. (See (c) in FIG. 11)

The injection molding of the first injection-molded component 100 may be performed by injecting a melted material (resin) into a cavity (first cavity 31) between the first outer mold 300 and the first inner mold 400 in a state in which the first outer mold 300 and the first inner mold 400 are closed.

As described above, multiple fastening bosses 150 may be formed on one first injection-molded component 100, and to this end, in the first operation (S210), multiple fastening bosses 150 may be formed spaced apart from each other along a longitudinal direction of the first split surface 110.

In the first operation (S210), the first protruding ledge 120 protruding from the first split surface 110 along a longitudinal direction of the first split surface 110 may be formed.

In the first operation (S210), a packing and cooling process is performed to complete the molding of the first injection-molded component 100.

In the second operation (S220), the second injection-molded component 200 having the second split surface 210 and the fastening hole 250 is injection-molded by the second mold 50. (See (c) in FIG. 11)

The injection molding of the second injection-molded component 200 may be performed by injecting a melted material (resin) into a cavity (second cavity 51) between the second outer mold 500 and the second inner mold 600 in a state in which the second outer mold 500 and the second inner mold 600 are closed.

As described above, multiple fastening holes 250 may be formed through one second injection-molded component 200, and to this end, in the second operation (S220), multiple fastening holes 250 may be formed spaced apart from each other along a longitudinal direction of the second split surface 210.

In an embodiment of the disclosure, an outer diameter of the fastening boss 150 formed in the first operation (S210) may be formed to be larger than an inner diameter of the fastening hole 250 formed in the second operation (S220).

In an embodiment of the disclosure, an outer diameter of the fastening boss 150 formed by the first mold 30 may be formed to be larger than an inner diameter of the fastening hole 250 formed by the second mold 50.

In the second operation (S220), the second protruding ledge 220 protruding from the second split surface 210 along a longitudinal direction of the second split surface 210 may be formed.

In the second operation (S220), a packing and cooling process is performed to complete the molding of the second injection-molded component 200.

In the method for manufacturing a hollow component according to an embodiment of the disclosure, the first operation (S210) and the second operation (S220) may be simultaneously performed. When the first operation (S210) and the second operation (S220) may be simultaneously performed, the operation including the first operation (S210) and the second operation (S220) is an injection operation (S200).

As described above, the method for manufacturing a hollow component according to an embodiment of the disclosure may be performed as a die slide injection (DSI) mold process. In the device 20 for manufacturing a hollow component according to an embodiment of the disclosure, the first outer mold 300 and the second inner mold 600 may be integrated with each other, and the first inner mold 400 and the second outer mold 500 may be integrated with each other.

The first actuator 60 is formed to close or open the first outer mold 300 and the first inner mold 400 with regard to each other.

In addition, the first actuator 60 may be formed to close or open the second outer mold 500 and the second inner mold 600.

The first actuator 60 may be formed as a device having various shapes to linearly move the entirety or a portion of a mold according to an embodiment of the disclosure. The first actuator 60 may include a hydraulic cylinder or include a hydraulic motor.

The first actuator 60 may be formed to move the first outer mold 300 and the second inner mold 600, or move the first inner mold 400 and the second outer mold 500. In an embodiment, the first actuator 60 may be formed to simultaneously move the first inner mold 400 and the second outer mold 500 with respect to the first outer mold 300 and the second inner mold 600. In an embodiment, the first actuator 60 may be formed to simultaneously move the first outer mold 300 and the second inner mold 600 with respect to the first inner mold 400 and the second outer mold 500.

When the first direction (X) is parallel with the vertical direction, the first actuator 60 may be formed to move up and down the first outer mold 300 and the second inner mold 600, or move up and down the first inner mold 400 and the second outer mold 500.

The method for manufacturing a hollow component may include a first mold-opening operation (S300).

The first mold-opening operation (S300) is performed after the first operation (S210) and the second operation (S220), and each of the first mold 30 and the second mold 50 may be opened in the first mold-opening operation (S300). The closing of the first mold 30 and the closing of the second mold 50 may be simultaneously performed. (See (b) in FIG. 10 and (d) in FIG. 11)

The first mold-opening operation (S300) may be performed by the first actuator 60. For example, the first mold-opening operation (S300) may be performed by moving the first inner mold 400 and the second outer mold 500 by the first actuator 60 in a state in which the first outer mold 300 and the second inner mold 600 are fixed.

The second actuator 70 may be formed as a device having various shapes to linearly move the entirety or a portion of a mold according to an embodiment of the disclosure. The second actuator 70 may include a hydraulic cylinder or include a hydraulic motor.

The second actuator 70 may move one or more of the first injection-molded component 100 and the second injection-molded component 200 such that the first split surface 110 and the second split surface 210 face each other in a state in which the first outer mold 300 and the first inner mold 400 are opened with regard to each other and the second outer mold 500 and the second inner mold 600 are opened with regard to each other.

When the first direction (X) is parallel with the vertical direction, the second actuator 70 may be formed to move one or more of the first injection-molded component 100 and the second injection-molded component 200 in a horizontal direction.

In an embodiment, the second actuator 70 may be formed to move the first inner mold 400 and the second outer mold 500 such that the first outer mold 300 and the second outer mold 500 face each other. In another embodiment, the second actuator 70 may be formed to move the first outer mold 300 and the second inner mold 600 such that the first outer mold 300 and the second outer mold 500 face each other.

In the third operation (S400), one or more of the first injection-molded component 100 and the second injection-molded component 200 may be moved such that the first split surface 110 and the second split surface 210 face each other. (See (c) in FIG. 10 and (e) in FIG. 11)

The third operation (S400) may be performed by the second actuator 70. The third operation (S400), as described above, may be performed by moving the first inner mold 400 and the second outer mold 500 by the second actuator 70 such that the first outer mold 300 and the second outer mold 500 face each other, or moving the first outer mold 300 and the second inner mold 600 by the second actuator 70 such that the first outer mold 300 and the second outer mold 500 face each other.

Relative movement between the first injection-molded component 100 and the second injection-molded component 200 is performed in the third operation (S400). The second injection-molded component 200 may move relative to the first injection-molded component 100, the first injection-molded component 100 may move relative to the second injection-molded component 200, or both the first injection-molded component 100 and the second injection-molded component 200 may move.

A direction of the relative movement between the first injection-molded component 100 and the second injection-molded component 200 in the third operation (S400) may be a direction orthogonal to the first direction (X).

In an embodiment, when the first direction (X) is the vertical direction, the first injection-molded component 100 and/or the second injection-molded component 200 may move along the horizontal direction in the third operation (S400).

In an embodiment, when the first direction (X) is the vertical direction and the third operation (S400) is completed, the first injection-molded component 100 and/or the second injection-molded component 200 may be arranged spaced apart from each other up and down. For example, the first injection-molded component 100 is located relatively on an upper side and the second injection-molded component 200 may be located relatively on a lower side.

The fourth operation (S510) may be performed after the third operation (S400).

The first injection-molded component 100 and the second injection-molded component 200 are relatively moved to approach each other in the fourth operation (S510). The first split surface 110 and the second split surface 210 approach each other, and the fastening boss 150 is simultaneously inserted into the fastening hole 250 in the fourth operation (S510).

The fourth operation (S510) may be performed by the first actuator 60.

The fifth operation (S520) may be performed after the fourth operation (S510).

The first injection-molded component 100 and the second injection-molded component 200 are relatively moved additionally in the fifth operation (S520). In the fifth operation (S520), the first split surface 110 and the second split surface 210 abut each other and the fastening boss 150 is completely inserted and press-fitted into the fastening hole 250. (See (d) in FIG. 10 and (f) in FIG. 11)

Accordingly, a press-fitting structure may be formed between the fastening boss 150 and the fastening hole 250.

The fifth operation (S520) may be performed by the first actuator 60.

In the fifth operation (S520), the first outer mold 300 and the second outer mold 500 are formed to closed with regard to each other.

As such, in an embodiment of the disclosure, closing of a mold is performed in the fourth operation (S510) and the fifth operation (S520). However, the closing is distinguished from the closing of the first mold-closing operation (S100) and thus is called as a second mold-closing operation (S500). (See (d) in FIG. 10 and (f) in FIG. 11)

In an embodiment of the disclosure, the fourth operation (S100) and the fifth operation (S520) constitute the second mold-closing operation (S500). The fourth operation (S510) is the previous operation of the second mold-closing operation (S500), and the fifth operation (S520) is the next operation of the second mold-closing operation (S500).

The first actuator 60 relatively moves the first injection-molded component 100 and the second injection-molded component 200 in a state in which the first split surface 110 and the second split surface 210 face each other such that the first split surface 110 and the second split surface 210 abut each other and the fastening boss 150 enters to be press-fitted into the fastening hole 250.

As described above, multiple fastening bosses 150 may be formed on one first injection-molded component 100 and multiple fastening holes 250 may be formed through one second injection-molded component 200, and here the fastening bosses 150 may be press-fitted into fastening holes 250, respectively, in the fifth operation (S520).

When multiple fastening bosses 150 are formed on one first injection-molded component 100 and multiple fastening holes 250 are formed through one second injection-molded component 200, the first actuator 60 and the second actuator 70 are formed to relatively move the first injection-molded component 100 and the second injection-molded component 200 such that the fastening bosses 150 are press-fitted into the fastening holes 250, respectively.

In an embodiment of the disclosure, a length of the fastening boss 150 may be formed to be longer than a length of the fastening hole 250, and when the fastening boss 150 is press-fitted into the fastening hole 250 in the fifth operation (S520), an end part of the fastening boss 150 having penetrated the fastening hole 250 may protrude out of the fastening hole 250.

In an embodiment, the first actuator 60 and the second actuator 70 may be formed to relatively move the first injection-molded component 100 and the second injection-molded component 200 such that the first protruding ledge 120 and the second protruding ledge 220 are brought into close contact with each other in an inward/outward direction.

In addition, the first actuator 60 and the second actuator 70 may be formed to relatively move the first injection-molded component 100 and the second injection-molded component 200 such that the first inner protruding ledge 121, the second inner protruding ledge 221, the first outer protruding ledge 122, and the second outer protruding ledge 222 are brought into close contact with each other in this order, or the second inner protruding ledge 221, the first inner protruding ledge 121, the second outer protruding ledge 222, and the first outer protruding ledge 122 are brought into close contact with each other in this order.

As such, according to the method for manufacturing a hollow component and the device 20 for manufacturing a hollow component according to an embodiment of the disclosure, it is possible to provide a manufacturing method and manufacturing device wherein the hollow component 10 may be manufactured while the first split surface 110 and the second split surface 210 are in contact with each other, coupling and fixation of the first injection-molded component 100 and the second injection-molded component 200 may be performed when the fastening boss 150 is press-fitted into the fastening hole 250, here, an additional injection process may not be necessary, and thus manufacture of the hollow part 10 may be facilitated and materials may be reduced.

The first injection-molded component 100 may have a predetermined temperature even after the molding of the first injection-molded component 100 is completed in the first operation (S210). In an embodiment of the disclosure, the first injection-molded component 100 may remain coupled to the first outer mold 300 of the first mold 30 from the first operation (S210) to the fifth operation (S520), and depending on an embodiment, the first injection-molded component 100 may have a predetermined temperature (e.g., a temperature of about 80° C. or higher, or a temperature of about 40° C. or higher) in the fifth operation (S520) after the first operation (S210). That is, the first injection-molded component 100 in the fifth operation (S520) is not completely cooled to a temperature range that reaches ordinary temperature, and has a predetermined temperature.

In addition, the second injection-molded component 200 may have a predetermined temperature even after the molding of the second injection-molded component 200 is completed in the second operation (S220). In an embodiment of the disclosure, the second injection-molded component 200 may remain coupled to the second outer mold 500 of the second mold 50 from the second operation (S220) to the fifth operation (S520), and depending on an embodiment, the second injection-molded component 200 may have a predetermined temperature (e.g., a temperature of about 80° C. or higher, or a temperature of about 40° C. or higher) in the fifth operation (S520) after the second operation (S220). That is, the second injection-molded component 200 in the fifth operation (S520) is not completely cooled to a temperature range that reaches ordinary temperature, and has a predetermined temperature.

In addition, when the first injection-molded component 100 is molded in the first operation (S210), a temperature may be controlled such that the first mold 30 remains within a predetermined temperature range, and after the molding of the first injection-molded component 100 is completed, the first mold 30 may have a predetermined temperature. According to an embodiment, in the fifth operation (S520) after the first operation (S210), the first mold 30 (specifically, the first outer mold 300) may be formed to have a predetermined temperature of about 40° C. or higher.

In addition, when the second injection-molded component 200 is molded in the second operation (S220), a temperature may be controlled such that the second mold 50 remains within a predetermined temperature range, and after the molding of the second injection-molded component 200 is completed, the second mold 50 may have a predetermined temperature. According to an embodiment, in the fifth operation (S520) after the second operation (S220), the second mold 50 (specifically, the second outer mold 500) may be formed to have a predetermined temperature of about 40° C. or higher.

As such, according to the method for manufacturing a hollow component according to an embodiment of the disclosure, the first injection-molded component 100 and the second injection-molded component 200 may maintained at a predetermined temperature in a range above ordinary temperature (20±5° C.) in the fifth operation (S520), and the fifth operation (S520) may be performed at this state.

In an embodiment, each of the first injection-molded component 100 and the second injection-molded component 200 may be controlled to remain within a temperature range of 40-80° C. in the fifth operation (S520).

In an embodiment, in the fifth operation (S520), a temperature of a periphery of the first injection-molded component 100 and the second injection-molded component 200 may be controlled such that the first injection-molded component 100 and the second injection-molded component 200 have a temperature of 40° C. or higher, and a temperature of the first mold 30 and the second mold 50 may be controlled.

In an embodiment of the disclosure, when the fastening boss 150 is press-fitted into the fastening hole 250 by the first actuator 60, the first mold 30 and the second mold 50 may be controlled to remain at a temperature of 40° C. or higher.

As described above, according to the method for manufacturing a hollow component and the device 20 for manufacturing a hollow component according to an embodiment of the disclosure, the fastening boss 150 is press-fitted into the fastening hole 250 in a state in which the first injection-molded component 100 and the second injection-molded component 200 are located in molds, and thus a temperature of the fastening boss 150 and the fastening hole 250 is not cooled to ordinary temperature but maintained within a predetermined range and the robust coupling of the fastening boss 150 and/or the fastening hole 250 without damage may be achieved.

If, unlike the disclosure, the assembling of the first injection-molded component 100 and the second injection-molded component 200 is performed outside the mold, a separate assembly process of the first injection-molded component 100 and the second injection-molded component 200 is required, thus causing manufacturing to be cumbersome. Furthermore, when the first injection-molded component 100 and the second injection-molded component 200 are cooled to a range of ordinary temperature to cause at least a portion of a material to be cured. When the assembling is performed in this state, the fastening boss 150 and the fastening hole 250 may be damaged or broken.

In the method for manufacturing a hollow component according to an embodiment of the disclosure, when the assembling of the hollow component 10 is completed, the second mold-opening operation (S600) is performed.

In the second mold-opening operation (S600), the first outer mold 300 and/or the second outer mold 500 is moved such that the first outer mold 300 and the second outer mold 500 are moved away from each other. The movement of the first outer mold 300 and/or the second outer mold 500 may be performed by the first actuator 60. (See (e) in FIG. 10 and (g) in FIG. 11)

When the product unloading operation (S700) is performed after the second mold-opening operation (S600), the hollow component 10 is separated from the mold in the product unloading operation (S700). (See (f) in FIG. 10 and (h) in FIG. 11)

The mold returning operation (S800) is performed after the product unloading operation (S700). (See (g) in FIG. 10)

In the mold returning operation (S800), each mold is moved such that the first outer mold 300 and the first inner mold 400 face each other, and the second outer mold 500 and the second inner mold 600 face each other. The movement of each mold may be performed by the second actuator 70.

FIG. 12 is a sectional view illustrating a coupling portion of a fastening boss 150 and a fastening hole 250 in a hollow component according to an embodiment of the disclosure.

In the method for manufacturing a hollow component according to an embodiment of the disclosure, when the fastening boss 150 is press-fitted into the fastening hole 250 in the fifth operation (S520), an end part of the fastening boss 150 having penetrated the fastening hole 250 may protrude out of the fastening hole 250.

Accordingly, the fastening boss 150 may be separated into a first boss part 150a and a second boss part 150b.

The first boss part 150a corresponds to a portion of the fastening boss 150 in close contact with the inner circumferential surface of the fastening hole 250 and the first boss part 150a is press-fitted into and strongly adhered to the fastening hole 250.

The second boss part 150b corresponds to a portion protruding out of the fastening hole 250.

In a process in which the fastening boss 150 is inserted into the fastening hole 250, the fastening boss 150 and the fastening hole 250 may be subjected to elastic deformation and/or plastic deformation.

When the assembly of the first injection-molded component 100 and the second injection-molded component 200 is completed, the maximum diameter of the second boss part 150b may be maintained to be slightly larger than a diameter of the first boss part 150a.

Therefore, when an external force is applied in a direction in which the fastening boss 150 and the fastening hole 250 are separated, the second boss part 150b may be caught by the fastening hole 250, and thus prevent the fastening boss 150 from being separated from the fastening hole 250 and help ensure stable coupling between the first injection-molded component 100 and the second injection-molded component 200.

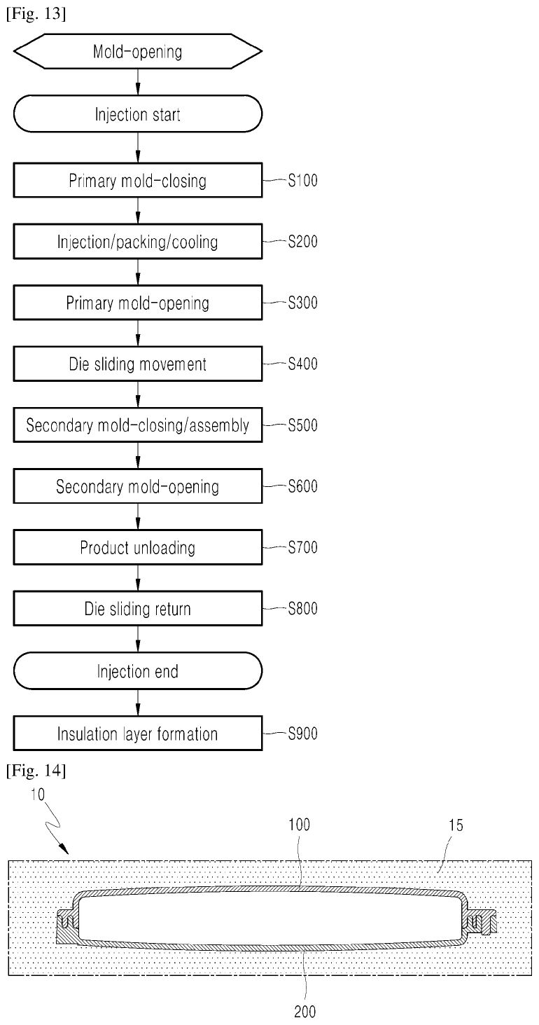

FIG. 13 is a view illustrating a process order of a method for manufacturing a hollow component according to an embodiment of the disclosure.

FIG. 14 is a sectional view illustrating a section of a hollow component 10 according to an embodiment of the disclosure.

The method for manufacturing a hollow component may further include a sixth operation (S900).

The sixth operation (S900) may be performed after the fifth operation (S520).

In the sixth operation (S900), an insulation layer 15 configured to surround the first injection-molded component 100 and the second injection-molded component 200 may be formed by foaming.

According to the method for manufacturing a hollow component and the device 20 for manufacturing a hollow component according to an embodiment of the disclosure, the first protruding ledge 120 and the second protruding ledge 220 may be coupled in an interlocking form, and thus help the first injection-molded component 100 and the second injection-molded component 200 to be stably coupled to each other.

In an embodiment, the first protruding ledge 120 and the second protruding ledge 220 are brought into close contact with each other in an inward/outward direction in the fifth operation (S520).

In an embodiment, in the fifth operation (S520), the first inner protruding ledge 121, the second inner protruding ledge 221, the first outer protruding ledge 122, and the second outer protruding ledge 222 are brought into close contact with each other in this order.

Furthermore, in an embodiment, in the fifth operation (S520), the second inner protruding ledge 221, the first inner protruding ledge 121, the second outer protruding ledge 222, and the first outer protruding ledge 122 are brought into close contact with each other in this order.

The first protruding ledge 120 and the second protruding ledge 220 may allow the internal airtightness of the hollow component 10 to be stably achieved, and prevent a foaming fluid used for forming the insulation layer 15 from penetrating into the first injection-molded component 100 and the second injection-molded component 200.

In the foregoing, specific embodiments of the disclosure have been described and illustrated, but it will be appreciated that the disclosure is not limited to the described embodiments, and those of ordinary skill in the art may make various modification and changes to other specific embodiments without departing from the spirit and scope of the disclosure. Therefore, the scope of the disclosure should be defined not by the above-described embodiments but by the technical idea defined in the following claims.

### INDUSTRIAL APPLICABILITY

The hollow component, the device for manufacturing a hollow component, and the method for manufacturing a hollow component according to an embodiment of the disclosure have the significantly high industrial applicability in that the fixation between a first injection-molded component and a second injection-molded component may be achieved without additional injection and breakage and damage of a fastening boss and a fastening hole may be prevented.

1.-19. (canceled)

20. A duct configured to be surrounded by an insulation layer formed by a foaming liquid, and comprising a first injection-molded component and a second injection-molded component, wherein a first split surface of the first injection-molded component and a second split surface of the second injection-molded component are coupled to each other in order to form a space inside in which fluid can flow,
wherein the first injection-molded component comprises:
a first inner protruding ledge that extends along the first split surface to form at least a portion of an inner surface that creates the space;
a first outer protruding ledge that extends parallel to the first inner protruding ledge, at a position spaced from the first inner protruding ledge in the outward direction of the space; and
multiple fastening bosses formed at positions spaced from the first outer protruding ledge,
wherein the second injection-molded component comprises:
a second inner protruding ledge extending along the second split surface, and coupled between the first inner protruding ledge and the first outer protruding ledge to prevent the infiltration of the foaming liquid into the space; and
multiple fastening holes formed at positions spaced from the second inner protruding ledge, and engaging with the plurality of fastening bosses, and
wherein the fastening bosses are formed larger than the fastening holes, such that when the second inner protruding ledge is coupled between the first inner protruding ledge and the first outer protruding ledge, the fastening bosses are press-fitted into the fastening holes for coupling.

21. The duct of claim 20, wherein the fastening bosses and the fastening holes are formed in a circular cross-section, and the diameter of the fastening bosses is formed larger than the inner diameter of the fastening holes.

22. The duct of claim 20, wherein the fastening bosses of the first injection-molded component are formed to be more adjacent to the first outer protruding ledge than the first inner protruding ledge.

23. The duct of claim 20, wherein the fastening boss is configured with a boss head at its upper part, having a larger cross-sectional area than the fastening boss itself, so that the fastening boss is press-fitted into the fastening hole by the force pressing on the boss head.

24. The duct of claim 23, wherein the fastening boss includes a first chamfer part formed at the underside of the boss head.

25. The duct of claim 21, wherein the fastening boss includes a second chamfer part formed at its lower part, with a diameter smaller than the inner diameter of the fastening hole, and
wherein the fastening boss is press-fitted into the fastening hole as the second chamfer part of the fastening boss passes through the fastening hole.

26. The duct of claim 21, wherein the fastening hole includes a third chamfer part formed at the entrance of the fastening hole, with a diameter larger than the diameter of the fastening boss, and
wherein the fastening boss is press-fitted into the fastening hole as the fastening boss passes through the third chamfer part.

27. The duct of claim 20, wherein the second injection-molded component comprises:
a second outer protruding ledge that extends parallel to the second inner protruding ledge, at a position spaced from the second inner protruding ledge in the outward direction of the space, and
wherein the first outer protruding ledge of the first injection-molded component is coupled between the second inner protruding ledge and the second outer protruding ledge.

28. The duct of claim 20, wherein the length of the fastening boss is formed to be greater than the length of the fastening hole, so that when the second inner protruding ledge is coupled between the first inner protruding ledge and the first outer protruding ledge, the lower part of the fastening boss protrudes from the fastening hole.

29. The duct of claim 27, wherein the fastening boss is formed with a first boss part, which is the portion inserted into the fastening hole, and a second boss part, which is the portion protruding from the fastening hole, and
wherein the cross-sectional area of the second boss part is larger than that of the first boss part.
